(19) United States
(12) Patent Application Publication
(10) Pub. No.: US 2022/0405605 A1
(43) Pub. Date: Dec. 22, 2022

(54) LEARNING SUPPORT DEVICE, LEARNING DEVICE, LEARNING SUPPORT METHOD, AND LEARNING SUPPORT PROGRAM

(71) Applicants: TOKYO WELD., LTD., Ota-ku, Tokyo (JP); MORPHO, INC., Chiyoda-ku, Tokyo (JP)

(72) Inventors: Yoshihiko YOKOYAMA, Ota-ku, Tokyo (JP); Tsukasa KATO, Ota-ku, Tokyo (JP); Daiju KIKUCHI, Ota-ku, Tokyo (JP); Takuma UMENO, Chiyoda-ku, Tokyo (JP)

(73) Assignees: TOKYO WELD., LTD., Ota-ku, Tokyo (JP); MORPHO, INC., Chiyoda-ku, Tokyo (JP)

(21) Appl. No.: 17/776,889

(22) PCT Filed: Dec. 18, 2020
(86) PCT No.: PCT/JP2020/047527

§ 371 Date: May 13, 2022

(30) Foreign Application Priority Data
Dec. 24, 2019 (JP) 2019-233202

(51) Int. Cl. G06N 5/02

(52) U.S. Cl. CPC G06N 5/022

(57) ABSTRACT

A training support device includes a derivation unit that derives a feature quantity of the training data, on the basis of a model trained using the training data, and training data having first data given a first label and second data given a second label, and derives, a feature quantity of the training candidate data, on the basis of at least one piece of training candidate data given any one of the first label and the second label, and the model, a calculation unit that calculates, at least one of a distance between the training candidate data and the first data and a second distance between the training candidate data and the second data, and a selection unit that selects data to be added as the training data from among the pieces of training candidate data, on the basis of the distance.

### TECHNICAL FIELD

The present disclosure relates to a training support device, a training device, a training support method, and a training support program.

### BACKGROUND ART

Patent Literature 1 discloses a device that identifies an image by using a model including a neural network and filter coefficients. The model receives a sample image from an input layer of the neural network, performs filtering processing based on the filter coefficients in an intermediate layer, and outputs information (class ID) indicating a classification of the sample image as a recognition result in an output layer. The model is trained in advance by using a training image, which is an image given a truth class ID. Specifically, the filter coefficient is set so that the neural network to which the training image has been input outputs the truth class ID. Further, this device presents the class ID identified by the model to a user together with the image, and causes the model to re-train an image after correction of the class ID when the class ID is corrected by the user.

### CITATION LIST

### Patent Literature

[Patent Literature 1] Japanese Unexamined Patent Publication No. 2016-143354

### SUMMARY OF INVENTION

### Technical Problem

Incidentally, an image that cannot be easily identified by a model can be training data having a high degree of contribution to a determination of parameters of a neural network and a high degree of training effect. Therefore, the high training efficiency can be realized by re-training the model using an image that cannot be easily identified by the model. However, although the device described in Patent Literature 1 causes the model to re-train an image whose class ID has been corrected by a user, in reality, images which the model classifies into a truth class might include an image classified barely into the truth class. Such an image can be said to be an image that cannot be easily identified by the model, but is excluded from candidates for re-training. Therefore, there is concern that the device described in Patent Literature 1 cannot efficiently train the model.

An object of the present disclosure is to provide a training support device, a training device, a training support method, and a training support program capable of appropriately supporting training of a model.

### Solution to Problem

A training support device according to the present disclosure includes

a training data acquisition unit configured to acquire training data having first data given a first label and second data given a second label; a training candidate data acquisition unit configured to acquire at least one piece of training candidate data given any one of the first label and the second label; a derivation unit configured to derive, for each piece of training data, a feature quantity of the training data represented in a feature space having predetermined dimensions, on the basis of a model trained using the training data so that target data is classified into any one of the first label and the second label, and the training data, and derive, for each piece of training candidate data, a feature quantity of the training candidate data represented in the feature space, on the basis of the model and the at least one piece of training candidate data; a calculation unit configured to calculate, for each piece of training candidate data, at least one of a first distance, the first distance being a distance between the training candidate data and the first data in the feature space, and a second distance, the second distance being a distance between the training candidate data and the second data in the feature space, on the basis of the feature quantity of the training data and the feature quantity of the at least one piece of training candidate data; and a selection unit configured to select data to be added as the training data from among the at least one piece of training candidate data, on the basis of the distance for each piece of training candidate data calculated by the calculation unit.

### Advantageous Effects of Invention

According to various aspects and embodiments of the present disclosure, it is possible to appropriately support the training of the model.

### BRIEF DESCRIPTION OF DRAWINGS

FIG. 1 is a block diagram illustrating an example of functions of a training device and a training support device according to an embodiment.

FIG. 2 is a block diagram illustrating a hardware configuration of the device illustrated in FIG. 1.

FIG. 3 is a schematic diagram of a neural network that is used in a training unit.

FIG. 4 is a diagram illustrating a distribution of feature quantities calculated by the neural network.

FIG. 5 is an illustrative diagram illustrating elements of a non-defective product distance and a defective product distance.

FIG. 6 is an illustrative diagram illustrating elements of a non-defective product distance and a defective product distance.

FIG. 7 is an illustrative diagram illustrating elements of a non-defective product distance and a defective product distance.

FIG. 8 is a flowchart of a training support method in the training device and the training support device.

FIG. 9 is a flowchart of training processing.

FIGS. 10(A) to 10(D) are diagrams illustrating examples of screens displayed on a display unit.

### DESCRIPTION OF EMBODIMENTS

Hereinafter, embodiments of the present disclosure will be described with reference to the drawings. In the following description, the same or equivalent elements are denoted by the same reference signs, and repeated description thereof will be omitted.

[Functional Configuration of Training Support Device]

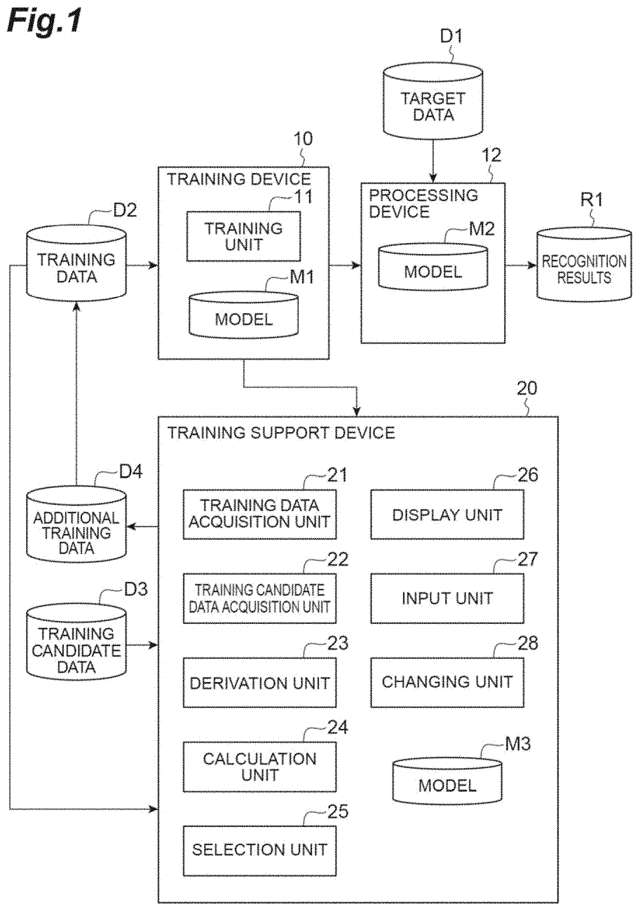

FIG. 1 is a block diagram illustrating an example of functions of a training device and a training support device according to an embodiment. A training device 10 illustrated in FIG. 1 is a device that trains a model M1. The model M1 has a structure including a neural network and parameters. The neural network has a structure in which a plurality of neurons are coupled. As an example, the neural network may be a hierarchical multi-layer neural network in which layers in which a plurality of neurons are grouped are connected. The neural network is defined by the number of neurons and a coupling relationship. A strength of coupling between the neurons or between the layers is defined using parameters (such as weighting coefficients). In the neural network, data is input, and a feature of the data is output as a solution on the basis of calculation results of a plurality of neurons, and the parameters. The training device 10 includes a training unit 11 that trains a parameter of the model M1 so that a desired ability can be acquired. The training is to adjust a parameter to an optimum value. Details of the neural network will be described below.

The training results of the training device 10 are utilized in a processing device 12. The processing device 12 has an execution environment in which a model M2 having the same neural network and parameters as the model M1 that is a training target of the training device 10 can be operated. The model M2 is the same model as the model M1, and the model M1 is a master (original). In the processing device 12, target data D1 is input to the model M2, and results are output from the model M2. The target data D1 is data that is processed to achieve a purpose of the processing device 12, and is, for example, image data, audio data, or graph data. The target data D1 is data before a label, which will be described below, is given. The purpose of the processing device 12 is recognition (classification), determination, and the like. The processing device 12 may be physically or logically separated from the training device 10 or may be integrated into the training device 10 and physically or logically integral with the training device 10.

The model M2 of the processing device 12 recognizes content of the target data D1 and outputs a label as the recognition results R1. The label is information for identifying a preset category, and is used for classifying or discriminating the target data D1. When the target data D1 is the image data, the label can be, for example, a type (person, vehicle, animal, or the like) of subject or quality (non-defective product, defective product, or the like) of the subject. The processing device 12 may give the output label to the target data D1. The giving means associating and, may be, for example, recording a relationship between the target data D1 and the label in a table or the like, may be changing attribute information of the target data D1 so that the label is included, or may be embedding the label in the target data itself.

Hereinafter, a case in which the model M2 of the processing device 12 receives the target data D1 whose subject is an electronic component and outputs a label regarding quality of the electronic component will be described as an example. In this case, the training unit 11 of the training device 10 trains the parameters of the neural network of the model M1 so that the model M2 of the processing device 12 can accurately discriminate the label of the target data D1.

The training unit 11 trains the model M1 on the basis of training data D2. The training data D2 is data in the same format as the target data D1 (here, image data), and a truth label is given to the training data D2 in advance. For example, any one of a non-defective product label (an example of a first label) indicating that an electronic component as a subject satisfies an appearance quality criterion and a defective product label (an example of a second label) indicating that the electronic component as the subject does not satisfy the appearance quality criterion is correctly given to the training data D2 by an annotator (worker) or the like. Therefore, the training data D2 includes non-defective product data given the non-defective product label (an example of first data) and defective product data given the defective product label (an example of second data).

The training unit 11 causes the neural network of the model M1 to train a feature of the non-defective product data and a feature of the defective product data, on the basis of non-defective product data and defective product data that are the training data D2. The model M1 outputs a score indicating the certainty of belonging to non-defective products (hereinafter referred to as a “non-defective product score”) for the input training data D2 and a score indicating the certainty of belonging to defective products (hereinafter referred to as a “defective product score”) for the input training data D2. In the present embodiment, each of the non-defective product score and the defective product score is set to a value in a range of 0.0 to 1.0, and a total of the non-defective product score and the defective product score is set to 1.0. The training unit 11 adjusts the parameters of the neural network of the model M1 so that the non-defective product score approaches 1.0 and the defective product score approaches 0.0 for the non-defective product data given the non-defective product label. On the other hand, the training unit 11 adjusts the parameters of the neural network of the model M1 so that the non-defective product score approaches 0.0 and the defective product score approaches 1.0 for the defective product data given the defective product label. Accordingly, the model M1 acquires an ability to classify the target data D1 into any one of a non-defective product label and a defective product label. The parameters trained by the training unit 11 are output to the processing device 12, and parameters of the model M2 of the processing device 12 are updated. Accordingly, the model M2 of the processing device 12 also acquires the ability to classify the target data D1 into any one of a non-defective product label and a defective product label.

The training support device 20 supports the training of the training device 10. The training support device 20 selects additional training data D4 for re-training of the model M1 from among the pieces of training candidate data D3. The training candidate data D3 is data (here, image data) in the same format as the training data D2, and a label is given to the training candidate data D3 by the annotator (worker) or the like in advance.

The training support device 20 includes a training data acquisition unit 21, a training candidate data acquisition unit 22, a derivation unit 23, a calculation unit 24, and a selection unit 25.

The training data acquisition unit 21 acquires training data D2 having non-defective product data given the non-defective product label and defective product data given the defective product label. The training data D2 is data that has been trained by the training unit 11. The training candidate data acquisition unit 22 acquires at least one piece of training candidate data D3 given any one of the non-defective product label and the defective product label. The training candidate data D3 is configured of one or a plurality of pieces of data. The training candidate data D3 may be configured only of data given the non-defective product label or may be configured only of data given the defective product label. Hereinafter, the training candidate data D3 is a plurality of pieces of data including both the data given the non-defective product label and the data given the defective product label.

The training data acquisition unit 21 and the training candidate data acquisition unit 22 may acquire the training data D2 or the training candidate data D3 from a data server (not illustrated) or the like via communication, or may acquire the training data D2 or the training candidate data D3 by referring to an external storage medium that can be connected to the training support device 20 or a storage medium included in the training support device 20. The training data acquisition unit 21 and the training candidate data acquisition unit 22 may acquire data obtained by a camera or the like. The data is given a label by a user.

The derivation unit 23 calculates, for each piece of training data D2, a feature quantity represented in a feature space having predetermined dimensions on the basis of the model M1 trained in the training unit 11 and the training data D2. The feature space having predetermined dimensions is a feature space for conversion that is used to facilitate calculation of a feature quantity having a huge number of dimensions. Therefore, the dimensions of the feature space may be two dimensions or three dimensions.

The feature quantity is a vector representing a feature of an image, and is extracted from a calculation process of the neural network of the model M1 to which the image has been input. The derivation unit 23 may operate the training device 10 so that the feature quantity is extracted for each piece of training data D2, and acquire the feature quantity from the training device 10. Alternatively, the derivation unit 23 may prepare the same model M3 as the model M1 and calculate, for each piece of training data D2, the feature quantity in the training support device 20. The model M3 is a model whose master (original) is the model M1.

The derivation unit 23 calculates, for each piece of training candidate data D3, the feature quantity represented in the feature space having the same dimensions as the feature space in which the feature quantity of the training data D2 is included, on the basis of the model M1 trained in the training unit 11 and at least one piece of training candidate data D3. The extraction of the feature of each piece of training candidate data D3 may be executed by the training device 10 as in the training data D2, or the same model M3 as the model M1 may be prepared and the training support device 20 may calculate the feature quantity for each piece of training data D2.

The calculation unit 24 calculates a distance between the training data D2 and the training candidate data D3 in the feature space. Specifically, the calculation unit 24 calculates, for each piece of training candidate data D3, a non-defective product distance (an example of a first distance) that is a distance between the training candidate data D3 and the non-defective product data in the feature space, on the basis of the feature quantity of the training data D2 and the feature quantity of the training candidate data D3. The calculation unit 24 calculates, for each piece of training candidate data D3, a defective product distance (an example of a second distance) that is a distance between the training candidate data D3 and the defective product data in the feature space, on the basis of the feature quantity of the training data D2 and the feature quantity of the training candidate data D3. The calculation unit 24 may calculate at least one of the non-defective product distance and the defective product distance. That is, the calculation unit 24 may calculate only the non-defective product distance or may calculate only the defective product distance. The calculation unit 24 may calculate an evaluation value for each piece of training candidate data D3 by using the non-defective product distance and the defective product distance. Detailed description of the non-defective product distance, the defective product distance, and the evaluation value, and calculation methods will be described below.

The selection unit 25 selects data to be added as the training data D2 (the additional training data D4) from among at least one piece of training candidate data D3 on the basis of the distance for each piece of training candidate data D3 calculated by the calculation unit 24. The selection unit 25 may use only the non-defective product distance or only the defective product distance as the distance for each piece of training candidate data D3. In the present embodiment, the selection unit 25 selects the additional training data D4 on the basis of both the non-defective product distance and the defective product distance for each piece of training candidate data D3. When the selection unit 25 determines that the additional training data D4 does not exist on the basis of the distance (at least one of the non-defective product distance and the defective product distance), the selection unit 25 causes a display unit 26 to be described below to display a determination result. A criteria for the determination will be described below.

Three methods below are illustrated as methods of the selection unit 25 selecting the additional training data D4. A first method is a method of the selection unit 25 increasing a probability of the training candidate data being selected from among at least one piece of training candidate data when the non-defective product distance of the training candidate data given the defective product label is smaller. A second method is a method of the selection unit 25 increasing a probability of the training candidate data being selected from among at least one piece of training candidate data D3 when the defective product distance of the training candidate data given the non-defective product label is smaller. A third method is a method of the selection unit 25 selecting the additional training data D4 on the basis of the evaluation value for each piece of training candidate data D3. The selection unit 25 can adopt any one of the three methods described above or a combination thereof. Details of each method will be described below.

The training support device 20 can include the display unit 26, an input unit 27, and a changing unit 28.

The display unit 26 displays the additional training data D4 selected by the selection unit 25. The display unit 26 may display not only an image of the additional training data D4, but also the label given to the additional training data D4, the non-defective product distance, the defective product distance, the evaluation value, the number of pieces of training candidate data, and the like. The display unit 26 may display a graph in which the feature quantity is plotted in a space having predetermined dimensions. The display unit 26 may be able to compare and display the training data D2 and the additional training data D4. The additional training data D4 is visualized by the display unit 26, making it is easy for the user to confirm a variation in quality of the additional training data D4 or to confirm the label, the non-defective product distance, the defective product distance, the evaluation value, or the number of pieces of training candidate data.

When the selection unit 25 determines that the additional training data D4 does not exist on the basis of the distance, the display unit 26 displays a determination result indicating that the additional training data D4 does not exist under the control of the selection unit 25. The selection unit 25 can report to the user that the additional training data does not exist, by causing the display unit 26 to display the determination result on a screen. The user can recognize that there is no additional training data D4 to be trained by the model M1, and can easily determine whether or not to end training of parameters such as weighting coefficients. The display unit 26 may report the determination result to the user in combination with, for example, output of an alarm sound from a speaker (not illustrated).

The input unit 27 receives an input of a user operation. The user operation is an operation that is performed by a user who operates the input unit 27 and is, for example, a selection operation or an input operation.

The changing unit 28 changes the label given to the additional training data D4 when a user operation for changing the label given to the additional training data D4 displayed on the display unit 26 is input via the input unit 27. The changing unit 28 causes the display unit 26 to display a screen for causing the user to confirm whether or not there is an error in the label given to the additional training data D4 in advance. When the user determines that there is an error in the label of the additional training data D4, the user changes the label of the additional training data D4 from the non-defective product label to the defective product label or from the defective product label to the non-defective product label using the changing unit 28 via the input unit 27.

[Hardware Configuration of Training Support Device]

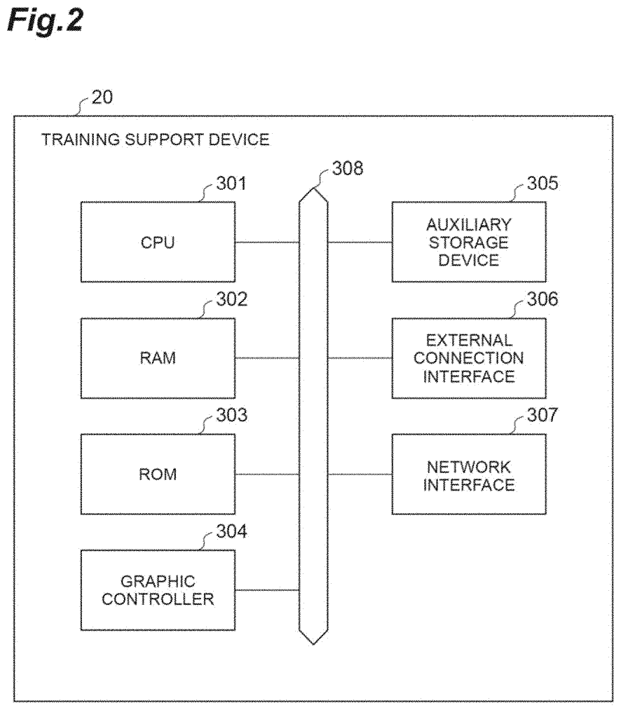

FIG. 2 is a block diagram illustrating a hardware configuration of the device illustrated in FIG. 1. As illustrated in FIG. 2, the training support device 20 includes a central processing unit (CPU) 301, a random access memory (RAM) 302, a read only memory (ROM) 303, a graphic controller 304, an auxiliary storage device 305, an external connection interface 306 (hereinafter, the interface is described as “I/F”), a network I/F 307, and a bus 308, and is configured as a normal computer system.

The CPU 301 is configured of a calculation circuit and generally controls the training support device 20. The CPU 301 reads a program stored in the ROM 303 or the auxiliary storage device 305 into the RAM 302. The CPU 301 executes various processing in the program read into the RAM 302. The ROM 303 stores a system program or the like that is used for control of the training support device 20. The graphic controller 304 generates a screen caused to be displayed on the display unit 26. The auxiliary storage device 305 has a function of a storage device. The auxiliary storage device 305 stores, for example, an application program for executing various processing. The auxiliary storage device 305 is configured of, for example, a hard disk drive (HDD), a solid state drive (SSD), or the like. The external connection I/F 306 is an interface for connecting various devices to the training support device 20. The external connection I/F 306, for example, connects the training support device 20, a display, a keyboard, a mouse, and the like. The network I/F 307 performs communication with the training support device 20 or the like via the network on the basis of control of the CPU 301. The respective components described above are communicatively connected via bus 308.

The training support device 20 may include hardware other than the above. The training support device 20 may include, for example, a graphics processing unit (GPU), a field-programmable gate array (FPGA), a digital signal processor (DSP), or the like. The training support device 20 does not have to be housed in one housing as hardware and may be separated into several devices.

A function of the training support device 20 illustrated in FIG. 1 is realized by hardware illustrated in FIG. 2. The training data acquisition unit 21, the training candidate data acquisition unit 22, the derivation unit 23, the calculation unit 24, the selection unit 25, and the changing unit 28 are realized by the CPU 301 executing a program stored in the RAM 302, ROM 303, or the auxiliary storage device 305 and processing data stored in the RAM 302, the ROM 303, or the auxiliary storage device 305 or data acquired via the external connection I/F 306 or the network I/F. The display unit 26 is a display device. The input unit 27 is a mouse, a keyboard, a touch panel, or the like. A function of the changing unit 28 may be realized by further using the graphic controller 304. The processing device 12 and the training device 10 illustrated in FIG. 1 are also configured of a part or all of the hardware illustrated in FIG. 2.

[Details of Neural Network]

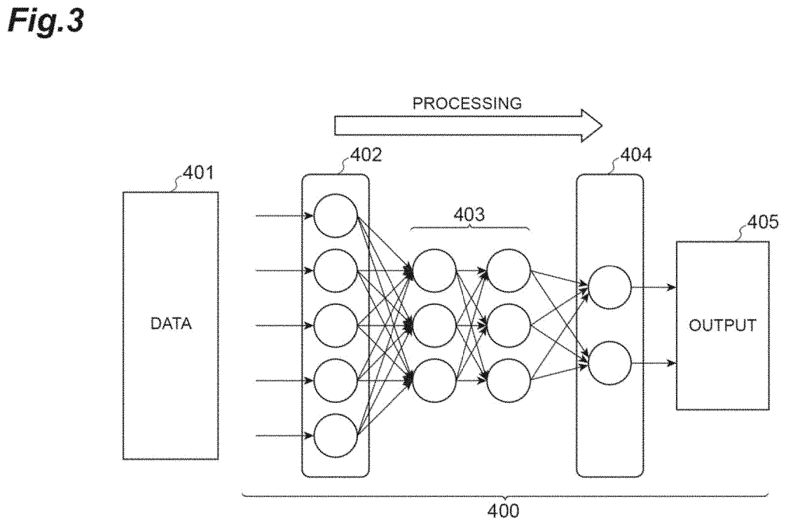

The neural network of the models M1 to M3 will be schematically described. FIG. 3 is a schematic diagram of the neural network. As illustrated in FIG. 3, a neural network 400 is a so-called hierarchical neural network, and a large number of artificial neurons (nodes) indicated by circles are connected while forming a hierarchy. A hierarchical neural network includes artificial neurons for inputting, artificial neurons for processing, and artificial neurons for outputting.

Data 401 is a processing target of the neural network. The data 401 is acquired by the artificial neurons for inputting in an input layer 402. The artificial neurons for inputting form the input layer 402 by being arranged in parallel. The data 401 is distributed to the artificial neurons for processing. A signal itself exchanged by the neural network is called a score. The score is a numerical value.

The artificial neurons for processing are connected to the artificial neurons for inputting. The artificial neurons for processing form an intermediate layer 403 by being arranged in parallel. The intermediate layer 403 may be a plurality of layers. A neural network having three or more layers including the intermediate layer 403 is called a deep neural network.

The neural network may be a so-called convolutional neural network. The convolutional neural network is a deep neural network in which convolutional layers and pooling layers are alternately connected. By sequential processing being performed in the convolutional layers and the pooling layers, the image of the data 401 is reduced with features such as edges held. When the convolutional neural network has been applied to image analysis, it is possible to classify images with high accuracy on the basis of an extracted feature of the data.

The artificial neurons for outputting outputs the score to the outside. In the example of FIG. 3, the non-defective product score and the defective product score are output from the artificial neurons for outputting. That is, in an output layer 404, two artificial neurons including an artificial neuron for outputting a non-defective product score and an artificial neuron for outputting a defective product score are prepared. The output layer 404 outputs the non-defective product score and the defective product score to the outside as an output 405. In the present embodiment, each of the non-defective product score and the defective product score is set to a value in a range of 0.0 to 1.0 and a total of the non-defective product score and the defective product score is set to 1.0. In training processing (S510) to be described below, training of the neural network 400 is performed so that the non-defective product score approaches 1.0 and the defective product score approaches 0.0 for the non-defective product data that is the training data given the non-defective product label. On the other hand, training of the neural network 400 is performed so that the non-defective product score approaches 0.0 and the defective product score approaches 1.0 for the defective product data that is the training data given the defective product label.

[Derivation of Feature Quantity in Derivation Unit]

As an example, the derivation unit 23 derives, for each piece of training data D2, the feature quantity represented in the feature space having predetermined dimensions by using the model M3 including the trained neural network 400 described above. The derivation unit 23 inputs the training data D2 acquired by the training candidate data acquisition unit 22 as the data 401 to the input layer 402 of the neural network 400. The artificial neurons for processing in the intermediate layer 403 process the input using trained weighting coefficients and propagate an output to other neurons. The derivation unit 23 acquires a calculation result of one layer selected from among the plurality of intermediate layers 403 as a feature quantity. As an example, the derivation unit 23 projects a calculation result of a layer (a layer at a stage immediately before the output layer 404) that propagates the score to the output layer 404 among the plurality of intermediate layers 403 to the feature space, and uses the calculation result as the feature quantity. Thus, the derivation unit 23 derives the feature quantity by using the trained model M3 and the training data D2.

Further, the derivation unit 23 derives, for each piece of training candidate data D3, a feature quantity represented in the feature space having predetermined dimensions by using the model M3 including the trained neural network 400 described above. The derivation unit 23 inputs the training candidate data D3 acquired by the training candidate data acquisition unit 22 as the data 401 to the input layer 402 of the neural network 400. The artificial neurons for processing in the intermediate layer 403 process the input using the trained weighting coefficients and propagate an output to other neurons. The derivation unit 23 acquires the calculation result of one layer selected from the plurality of intermediate layers 403 as the feature quantity. As an example, the derivation unit 23 projects the calculation result of the layer (the layer at a stage immediately before the output layer 404) that propagates the score to the output layer 404 among the plurality of intermediate layers 403 to the feature space, and uses the calculation result as the feature quantity. Thus, the derivation unit 23 derives the feature quantity by using the trained model M3 and the training candidate data D3.

The derivation unit 23 may operate the training device 10 so that the feature quantity is extracted, and acquire the feature quantity from the training device 10. In this case, the training device 10 calculates the feature quantity through the same scheme as the above-described scheme using the model M1.

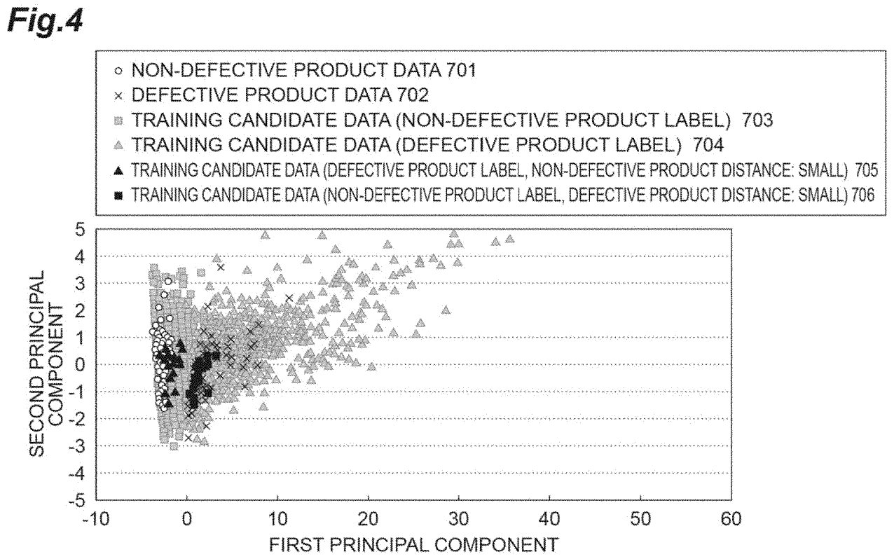

FIG. 4 is a diagram illustrating a distribution of feature quantities calculated by the neural network. A graph illustrated in FIG. 4 shows the feature quantity of the training data D2 and the feature quantity of the training candidate data D3 projected onto a two-dimensional space, a horizontal axis indicates a first principal component, and a vertical axis indicates a second principal component. As illustrated in FIG. 4, a feature quantity 701 of the non-defective product data that is the training data D2 given the non-defective product label and a feature quantity 702 of the defective product data that is the training data D2 given the defective product label form respective point groups and there is a boundary surface between the point groups. In the graph illustrated in FIG. 4, a feature quantity 703 of the training candidate data D3 given the non-defective product label and a feature quantity 704 of the training candidate data D3 given the defective product label extracted by the derivation unit 23 are also included. The training candidate data D3 is plotted regardless of the boundary surface.

[Calculation of Non-Defective Product Distance and Defective Product Distance in the Calculation Unit]

The calculation unit 24 calculates the non-defective product distance, which is a distance between the training candidate data D3 and the non-defective product data in the feature space, on the basis of a corresponding feature quantity for each piece of training candidate data D3. An Euclidean distance between pieces of data projected onto the feature space, for example, can be used as a “distance” that is used to represent the non-defective product distance and the defective product distance. The distance is not limited to the Euclidean distance as long as the distance in the feature space can be calculated, and a Mahalanobis distance or the like can also be used. A distance between training data k that is one of the training data D2 and the training candidate data s that is one of the training candidate data D3 is calculated by, for example, Equation 1 below.

$$[ Equation 1 ]$$

$${d}_{( k , s )} ( {\vec{p}}_{s} , {\vec{q}}_{k} ) = \sqrt{{\sum }_{j = 1}^{j} {( {q}_{( k , i )} - {p}_{( s , i )} )}^{2}} \qquad ( 1 )$$

Here, q_{(k,i)}, is coordinates in a certain dimension i in the feature space of the training data k, and p_{(s,i)} is coordinates in the certain dimension i in the feature space of the training candidate data s. d_{(k,s)} is a distance between the training data k and the training candidate data s, a vector of qₖ is a set of pieces of coordinate data in the feature space of the training data k, and a vector of pₖ is a set of pieces of coordinate data in the feature space of the training candidate data s. k is an integer equal to or smaller than the number of pieces of training data (m+n: m and n are integers), i is an integer equal to or smaller than a predetermined number (j) of dimensions (j is an integer), and s is an integer equal to or smaller than the number (t) of pieces of training candidate data (t is an integer).

When a distance from the training candidate data s to non-defective product data OKg, which is one of non-defective product data OK, is d<_{(OKg,s)}, d_{(OKg,s)} is expressed as shown in Equation 2 below by using Equation 1. In OKg, OK is a code indicating a non-defective product, and g is an integer equal to or smaller than the number of pieces of data (m) of the non-defective product data OK.

$$[ Equation 2 ]$$

$${d}_{( OKg , s )} ( {\vec{p}}_{s} , {\vec{q}}_{OKg} ) = \sqrt{{\sum }_{i = 1}^{j} {( {q}_{( OKg , i )} - {p}_{( x , i )} )}^{2}} \qquad ( 2 )$$

q_{(OKg,i)} is coordinates in a certain dimension i in the feature space of the non-defective product data OKg in the training data D2, and a vector of g_{OKg} is a set of pieces of coordinate data of the feature space of the non-defective product data OKg.

When a set of distances between the training candidate data s and the respective pieces of non-defective product data OK is a vector of d_{(OK, s)}, the vector of d_{(OK,s} is expressed as shown in Equation 3 below by using Equation 2.

$$[ Equation 3 ]$$

$${{d}_{( OK , s )}}^{⟶} = ( {d}_{( OK 1 , s )} , {d}_{( OK 2 , s )} , … , {d}_{( OKm , s )} ) \qquad ( 3 )$$

A non-defective product distance E_{(OK, s)} in the training candidate data s is, for example, a minimum value among elements of the vector of d_{(OK,s)}. That is, the non-defective product distance E_{(OK,s)} is a minimum value among the elements of the vector of d_{(OK, s)}, which is a set of distances between the training candidate data s and the respective pieces of non-defective product data OK. The non-defective product distance E_{(OK, s)} is expressed as shown in Equation 4 below by using Equation 3. In this case, when the non-defective product distance E_{(OK, s)} is smaller, this indicates that the training candidate data s is located near any one of the pieces of non-defective product data OK in the feature space.

$$[ Equation 4 ]$$

$${E}_{( OK , s )} = min \{ f ( x ) \vert x ∈ {{d}_{( OK , s )}}^{⟶} \} \qquad ( 4 )$$

The non-defective product distance E_{(OK, s)} in the training candidate data s may be, for example, an average value of a elements that are extracted from small elements among elements of the vector of d_{(OK, s)}. a is a natural number and, for example, is 3. The non-defective product distance E_{(OK, s)} in this case is expressed as shown in Equation 5 below by using Equation 3. In this case, when the non-defective product distance E_{(OK,s)} is smaller, this indicates that the training candidate data s is located near the plurality of (a) pieces of non-defective product data OK in the feature space, and indicates the training candidate data s is close to a cluster of pieces of non-defective product data OK (a non-defective product cluster).

$$[ Equation 5 ]$$

$${E}_{OK , s )} = \frac{1}{a} {\sum }_{l = 1}^{a} {min}_{l} \{ f ( x ) \vert x ∈ {{d}_{( OK , s )}}^{⟶} \} \qquad ( 5 )$$

Further, the calculation unit 24 calculates the defective product distance, which is the distance between the training candidate data D3 and the defective product data in the feature space, on the basis of the corresponding feature quantity for each piece of training candidate data D3. When a distance from the training candidate data s to a defective product data NGh among defective product data NG is d_{(NGh, s)}, d_{(NGh, s)} is expressed as shown in Equation 6 below by using Equation 1. Among NGh, NG is a code indicating a defective product, and h is an integer equal to or smaller than the number (n) of pieces of defective product data NG.

$$[ Equation 6 ]$$

$${d}_{( NGh , s )} ( {\vec{p}}_{s} , {\vec{q}}_{NGh} ) = \sqrt{{\sum }_{i = 1}^{\text{?}} {( {q}_{( NGh , i )} - p \text{?} )}^{2}} \qquad ( 6 )$$

$$\text{?} \text{indicates text missing or illegible when filed}$$

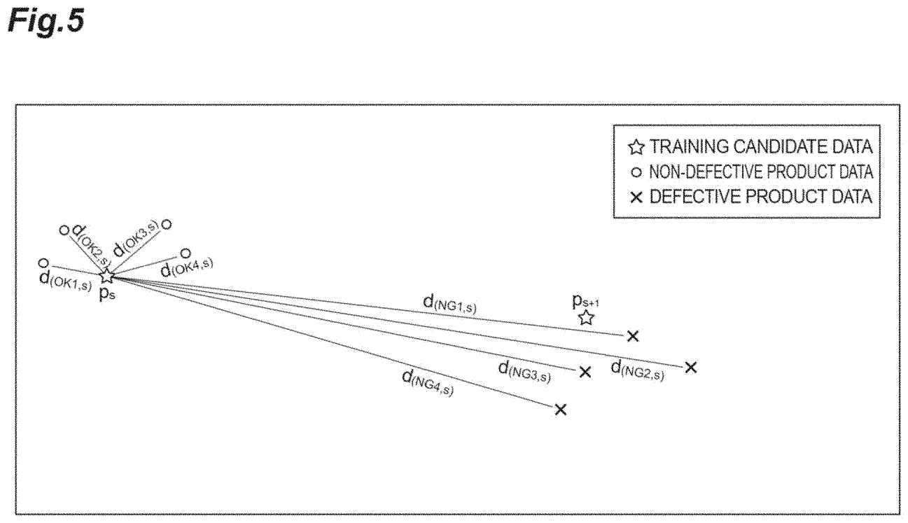

q_{(NGh, i)} is coordinates in a certain dimension i in the feature space of the defective product data NGh among the training data, and a vector of q_{NGh} is a set of pieces of coordinate data in the feature space of the defective product data NGh. FIG. 5 is an illustrative diagram illustrating elements of the non-defective product distance and the defective product distance. As illustrated in FIG. 5, d_{(OKk, s)} and d_{(NGk, s)} are calculated for the training data D2 and the training candidate data s.

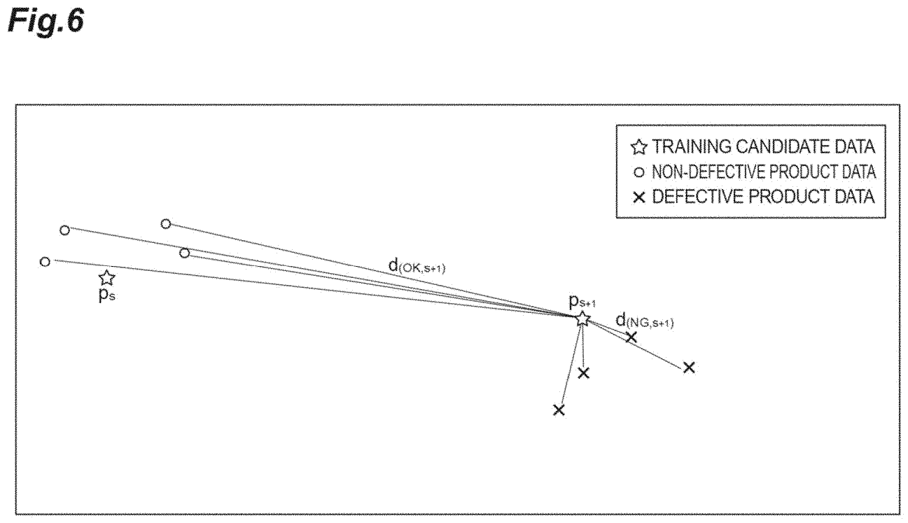

When a set of distances between the training candidate data s and the respective pieces of defective product data NG is a vector of d_{(NG, s)}, the vector of d_{(NG, s)} is expressed as shown in Equation 7 below by using Equation 6. FIG. 6 is an illustrative diagram illustrating elements of the non-defective product distance and the defective product distance. In FIG. 6, a vector of d_{(OK, s+1)} and a vector of d_{(NG, s+1)} for certain training candidate data s+1 are shown.

$$[ Equation 7 ]$$

$${{d}_{( NG , s )}}^{⟶} = ( {d}_{( NG 1 , s )} , {d}_{( NG 2 , s )} , … , {d}_{( NGn , s )} ) \qquad ( 7 )$$

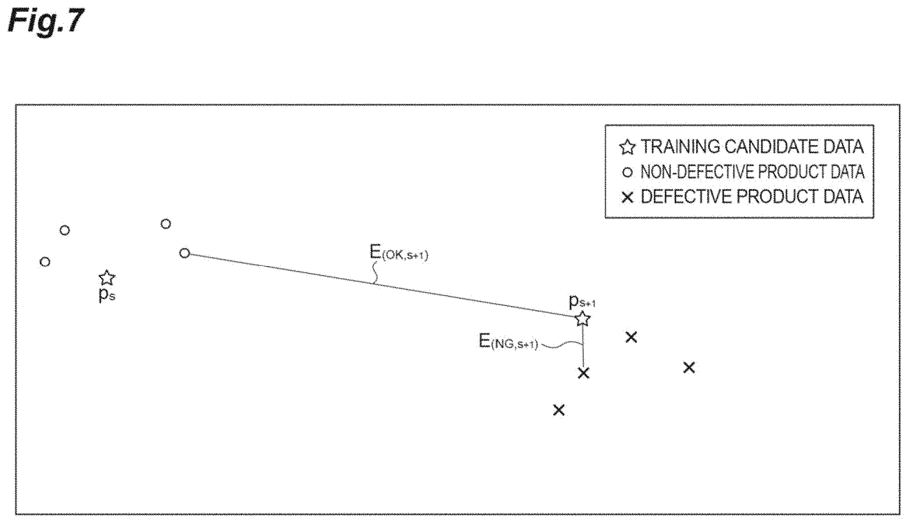

A defective product distance E_{(NG, s)} in the training candidate data s is, for example, a minimum value among the vector elements of d_{(NG, s)}. That is, the defective product distance E_{(NG, s)} is a minimum value among distances between the training candidate data s and the respective pieces of defective product data NG. The defective product distance E_{(NG, s)} is expressed as shown in Equation 8 below by using Equation 7. In this case, when the defective product distance E_{(NG, s)} is smaller, this indicates that the training candidate data s is located near any one of the pieces of defective product data NG in the feature space. FIG. 7 is an illustrative diagram illustrating the non-defective product distance and the defective product distance. In FIG. 7, a case in which a minimum value of a distance from the non-defective product data OK and a minimum value of a distance from the defective product data NG in the training candidate data s+1 are a non-defective product distance E_{(OK, s+1)} and a defective product distance E_{(NG, s+1)} is shown.

$$[ Equation 8 ]$$

$${E}_{( NG , s )} = min \{ f ( x ) \vert x ∈ {{d}_{( NG , s )}}^{⟶} \} \qquad ( 8 )$$

The defective product distance E_{(NG, s)} in the training candidate data s may be, for example, an average value of a elements that are extracted from among small elements among the elements of the vector of d_{(NG, s)}. The defective product distance E_{(NG, s)} in this case is expressed as shown in Equation 9 below by using Equation 7. In this case, when the defective product distance E_{(NG, s)} is smaller, this indicates that the training candidate data s is located near a plurality of (a) pieces of defective product data NG in the feature space and indicates that the training candidate data s is close to a cluster of pieces of defective product data NG (a defective product cluster).

$$[ Equation 9 ]$$

$${E}_{( NG , s )} = \frac{1}{a} {\sum }_{l = 1}^{a} {min}_{l} \{ f ( x ) \vert x ∈ {{d}_{( NG , s )}}^{⟶} \} \qquad ( 9 )$$

Further, the calculation unit 24 calculates an evaluation value Eₛ in the training candidate data s by using the calculated non-defective product distance E_{(OK, s)}, and defective product distance E_{(NG, s)}. The evaluation value Eₛ is, for example, a value obtained by dividing the non-defective product distance E_{(OK, s)} by the defective product distance E_{(NG, s)}, and is expressed as shown in Equation 10 below.

$$[ Equation 10 ]$$

$${E}_{s} = \frac{{E}_{( OK , s )}}{{E}_{( NG , s )}} \qquad ( 10 )$$

For example, when the evaluation value Eₛ is smaller than 1, this indicates that the non-defective product distance E_{(OK, s)} is smaller than the defective product distance E_{(NG, s)}, and the training candidate data s is data closer to the non-defective product cluster than the defective product cluster. Therefore, in a case in which the training candidate data s is data having the defective product label, when the evaluation value Eₛ is smaller, this indicates that the training candidate data s is data difficult to classify into the non-defective product label and the defective product label in the models M1, M2, and M3 in a training result of the training data D2 at a current stage, and is data having a high training effect for the models M1, M2, and M3.

On the other hand, for example, when the evaluation value Eₛ is larger than 1, this indicates that the defective product distance E_{(NG, s)} is smaller than the non-defective product distance E_{(OK, s)}, and the training candidate data s is data closer to the defective product cluster than the non-defective product cluster. Therefore, in a case in which the training candidate data s is data having the non-defective product label, when the evaluation value Eₛ is larger, this indicates that the training candidate data s is data difficult to classify into the non-defective product label and the defective product label in the models M1, M2, and M3 in the training result of the training data D2 at a current stage, and is data having a high training effect for the models M1, M2, and M3.

The evaluation value may be a value obtained by dividing the defective product distance E_{(NG, s)} by the non-defective product distance E_{(OK, s)}. In this case, the above determination is reversed. That is, when the evaluation value Eₛ is larger than 1, this indicates that the non-defective product distance E_{(OK, s)} is smaller than the defective product distance E_{(NG, s)}, and the training candidate data s is data closer to the non-defective product cluster than the defective product cluster. Further, when the evaluation value Eₛ is smaller than 1, this indicates that the defective product distance E_{(NG, s)} is smaller than the non-defective product distance E_{(OK, s)}, and the training candidate data s is data closer to the defective product cluster than the non-defective product cluster. Further, the evaluation value may be a value obtained by performing predetermined calculation processing on the value obtained by dividing as described above.

[Method of Selecting Training Candidate Data in Selection Unit]

The selection unit 25 selects the additional training data D4 from among the pieces of training candidate data D3 on the basis of at least one of the non-defective product distance E_{(OK, s)}, the defective product distance E_{(NG, s)}, and the evaluation value Eₛ calculated by the calculation unit 24. Here, as training of the weighting coefficients in the neural network 400, the training candidate data s that cannot be easily identified by the neural network 400 has a high training effect and can shorten a time required for training. Therefore, the selection unit 25 is required to select the data to be added as the training data D2 (the additional training data D4) from among the pieces of training candidate data D3 on the basis of a level of the training effect.

First, a method of increasing a probability of the training candidate data being selected from among at least one piece of training candidate data D3 when the defective product distance E_{(OK, s)}, of the training candidate data given the non-defective product label is smaller in the selection unit 25 will be described. Here, the selection unit 25 increases a probability of being selected from among the pieces of training candidate data D3 when the training candidate data given the defective product label has a smaller non-defective product distance E_{(OK, s)} in a case in which the non-defective product distance E_{(OK, s)} is smaller than a predetermined threshold value. For example, the selection unit 25 selects the training candidate data having the non-defective product distance E_{(OK, s)} smaller than the predetermined threshold value and having the defective product label in ascending order of the non-defective product distance E_{(OK, s)} up to a predetermined upper limit number of pieces of additional training data D4. In FIG. 4, a feature quantity 705 of the training candidate data given the defective product label extracted by the derivation unit 23 is projected onto the two-dimensional space. The training candidate data that is close to the non-defective product data OK (non-defective product cluster) having the non-defective product label, and has the defective product label cannot be easily identified by the neural network 400 at a stage in which the training data D2 has been applied and processing has been performed. Thus, it is possible to select the additional training data D4 having a high training effect for the neural network 400 by the selection unit 25 selecting the additional training data D4 as described above. The selection unit 25 determines that the additional training data D4 does not exist when all of the pieces of training candidate data D3 are only data having the non-defective product distance E_{(OK, s)} equal to or larger than the predetermined threshold value, and causes the display unit 26 to display a determination result. The selection unit 25 may determine that the additional training data D4 does not exist when the number of pieces of data of the training candidate data D3 having a non-defective product distance E_{(OK, s)} smaller than the predetermined threshold value is equal to or smaller than a certain threshold value, and cause the display unit 26 to display a determination result.

Further, a method of increasing the probability of the training candidate data being selected from among at least one piece of training candidate data D3 when the defective product distance E_{(NG, s)} of the training candidate data given the non-defective product label is smaller in the selection unit 25 will be described. Here, the selection unit 25 increases a probability of being selected from among the pieces of training candidate data D3 when the training candidate data given the non-defective product label has a smaller defective product distance E_{(NG, s)} in a case in which the defective product distance E_{(NG, s)} is smaller than the predetermined threshold value. For example, the selection unit 25 selects the training candidate data having the defective product distance E_{(NG, s)} smaller than the predetermined threshold value and having the non-defective product label in ascending order of the defective product distance E_{(NG, s)} up to a predetermined upper limit number of pieces of additional training data D4. In FIG. 4, the feature quantity 706 of the training candidate data given the non-defective product label extracted by the derivation unit 23 is projected onto the two-dimensional space. The training candidate data that is close to the defective product data NG (defective product cluster) having the defective product label, and has the non-defective product label cannot be easily identified by the neural network 400 at a stage in which the training data D2 has been applied and processing has been performed. Thus, it is possible to select the additional training data D4 having a high training effect for the neural network 400 by the selection unit 25 selecting the additional training data D4 as described above. The selection unit 25 determines that the additional training data D4 does not exist when all of the pieces of training candidate data D3 are only data having the defective product distance E_{(NG, s)} equal to or larger than the predetermined threshold value, and causes the display unit 26 to display a determination result. The selection unit 25 may determine that the additional training data D4 does not exist when the number of pieces of data of the training candidate data D3 having the defective product distance E_{(NG, s)} smaller than the predetermined threshold value becomes equal to or smaller than the certain threshold value, and cause the display unit 26 to display a determination result.

Further, a method of the selection unit 25 selecting the additional training data D4 on the basis of the evaluation value Eₛ for each piece of training candidate data will be described. The selection unit 25, for example, increases the probability of the training candidate data being selected from among at least one piece of training candidate data D3 when the evaluation value Eₛ of each piece of training candidate data s having the non-defective product label is larger. For example, the selection unit 25 selects the training candidate data having the non-defective product label in descending order of evaluation value Eₛ up to a predetermined upper limit number of pieces of additional training data D4. The training candidate data s having a large evaluation value Eₛ corresponds to at least one of a case in which a distance to the non-defective product data OK having the non-defective product label is large and a case in which a distance to the defective product data NG having the defective product label is small, as illustrated in FIG. 7, as compared with the training candidate data s having a small evaluation value Eₛ. Therefore, the training candidate data having the non-defective product label cannot be easily identified by the neural network 400 at a stage in which the training data D2 has been applied and processing has been performed. Further, the fact that the evaluation value Eₛ is larger than 1 indicates that the training candidate data s is closer to the defective product cluster than the non-defective product cluster. Thus, the selection unit 25 selects, for example, training candidate data having the evaluation value Eₛ larger than 1 and having the non-defective product label as the additional training data D4 in descending order of the evaluation value Eₛ, thereby selecting the additional training data D4 having a high training effect for the neural network 400. The selection unit 25 determines that the additional training data D4 does not exist when all of the pieces of training candidate data D3 are only data having the evaluation value Eₛ smaller than a predetermined threshold value, and causes the display unit 26 to display a determination result. The selection unit 25 may determine that the additional training data D4 does not exist when the number of pieces of data of the training candidate data D3 having the evaluation value Eₛ equal to or larger than the predetermined threshold value is equal to or smaller than the certain threshold value, and cause the display unit 26 to display a determination result.

The selection unit 25, for example, may increase the probability of the training candidate data being selected from among at least one piece of training candidate data D3 when the evaluation value Eₛ of each piece of training candidate data s having the defective product label is smaller. For example, the selection unit 25 selects the training candidate data having the defective product label in ascending order of the evaluation value Eₛ up to a predetermined upper limit number of pieces of additional training data D4. The training candidate data s having a small evaluation value Eₛ corresponds to at least one of a case in which a distance to the defective product data NG having the defective product label is large and a case in which a distance to the non-defective product data OK having the non-defective product label is small, as compared with the training candidate data s having a large evaluation value Eₛ. Therefore, the training candidate data having the defective product label cannot be easily identified by the neural network 400 at a stage in which the training data D2 has been applied and processing has been performed. Further, the fact that the evaluation value Eₛ is smaller than 1 indicates that the training candidate data s is closer to the non-defective product cluster than the defective product cluster. Thus, the selection unit 25 selects, for example, training candidate data having the defective product label as the additional training data D4 in ascending order of the evaluation value Eₛ, thereby selecting the additional training data D4 having a high training effect for the neural network 400. The selection unit 25 determines that the additional training data D4 does not exist when all of the pieces of training candidate data D3 are only data having the evaluation value Eₛ equal to or larger than the predetermined threshold value, and causes the display unit 26 to display a determination result. The selection unit 25 may determine that the additional training data D4 does not exist when the number of pieces of data of the training candidate data D3 having the evaluation value Eₛ smaller than the predetermined threshold value is equal to or smaller than the certain threshold value, and cause the display unit 26 to display a determination result. Further, the selection unit 25 selects the additional training data D4 by appropriately switching a magnitude relationship according to a method of calculating the evaluation value Eₛ.

[Operation of Training Device and Training Line-of-Sight Device]

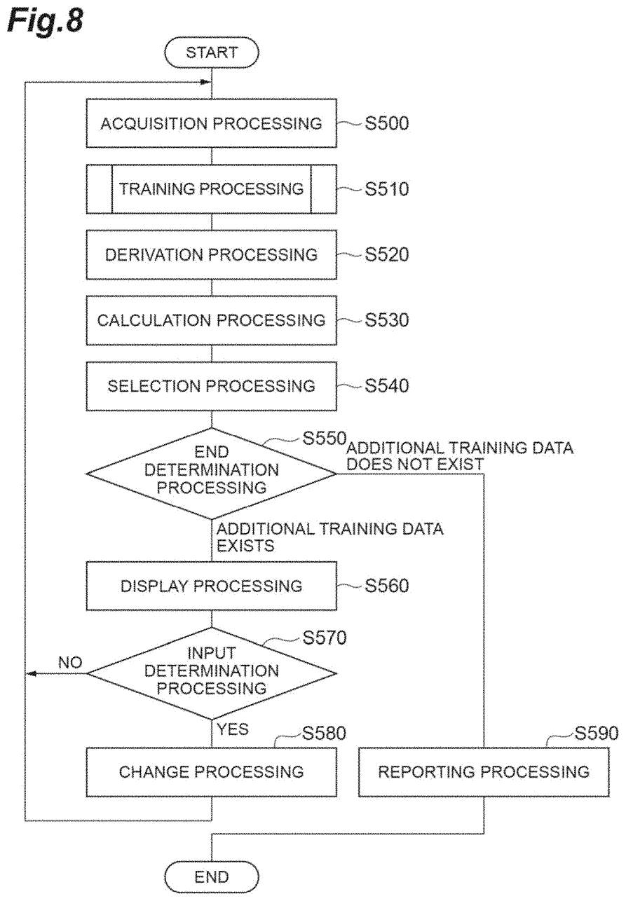

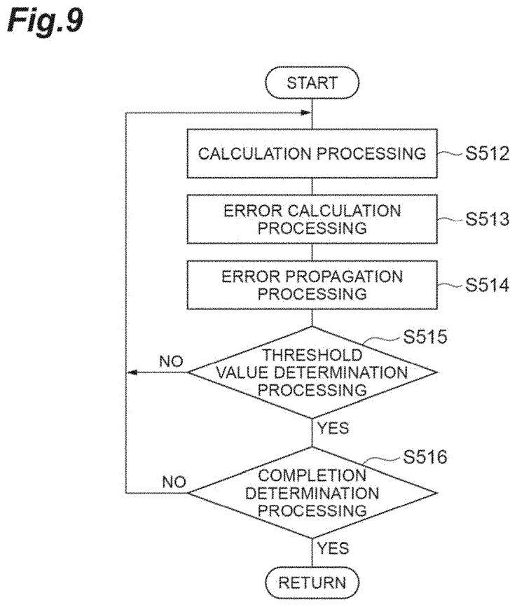

FIG. 8 is a flowchart of a training method and a training support method. The training support method in the training support device 20 includes acquisition processing (S500; an example of a first step), derivation processing (S520; an example of a second step), calculation processing (S530; an example of a third step), and selection processing (S540; an example of a fourth step). The training support method may include display processing (S560), input determination processing (S570), change processing (S580), and reporting processing (S590). The training method in the training device 10 includes training processing (S510) (see FIG. 9).

First, the training data acquisition unit 21 of the training support device 20, for example, acquires the training data D2 having the non-defective product data OK given the non-defective product label and the defective product data NG given the defective product label, from the data server, in the acquisition processing (S500). The training candidate data acquisition unit 22 of the training support device 20 acquires, for example, at least one piece of training candidate data D3 given any of the non-defective product label and the defective product label from the data server in the acquisition processing (S500).

The training unit 11 of the training device 10 trains the training data D2 as the training processing (S510), and adjusts the weighting coefficients in the neural network 400 of the model M1. FIG. 9 is a flowchart of the training processing. The training unit 11 causes the neural network 400 of the model M1 to train the training data D2 in calculation processing (S512). In this calculation processing (S512), the non-defective product score and the defective product score are output for the training data D2 from the neural network 400. The training unit 11 calculates an error between the label given to the training data D2 and the score output for the training data D2 in error calculation processing (S513). The training unit 11 adjusts weighting coefficients of the intermediate layer 403 of the neural network 400 by using the error calculated in the error calculation processing (S513), in back propagation processing (S904). The training unit 11 determines whether or not the error calculated in the error calculation processing (S513) is smaller than a predetermined threshold value in threshold value determination processing (S515). When it is determined that the error is not smaller than the predetermined threshold value (S515: NO), the processing of S512 to S515 is repeated again. When it is determined that the error is smaller than the predetermined threshold value (S515: YES), the processing proceeds to completion determination processing (S906).

A use case in which the non-defective product data OK given the non-defective product label “1” has been input will be described as a specific example of processing from the calculation processing (S512) to the threshold value determination processing (S515). When the calculation processing (S512) is performed on the training data D2 for the first time, values of “0.9” and “0.1” are output as the non-defective product score and the defective product score from the neural network 400 of the model M1, respectively. Then, in the error calculation processing (S513), a difference “0.1” between the non-defective product label “1” and the non-defective product score “0.9” is calculated. In the case of the defective product data NG given the defective product label, a difference from the defective product score is calculated. Then, in the error propagation processing (S514), the weighting coefficients of the intermediate layer 403 of the neural network 400 of the model M1 are adjusted so that the error calculated in the error calculation processing (S513) becomes smaller. In the threshold value determination processing (S515), the adjustment of the weighting coefficients is repeated until it is determined that the error calculated in the error calculation processing (S513) is smaller than the predetermined threshold value, so that machine learning of the neural network 400 of the model M1 is performed and the model M1 acquires an ability to classify the target data into any one of the non-defective product label and the defective product label.

Then, in completion determination processing (S516), it is determined whether or not the processing has been completed for all the pieces of training data D2. When it is determined that the processing has not been completed for all the pieces of training data D2 (S516: NO), the processing of S511 to S516 is repeated again. When it is determined that the processing has been completed for all the pieces of training data D2 (S516: YES), the flowchart of FIG. 9 ends, and the processing returns to the flowchart of FIG. 8.

The derivation unit 23 of the training support device 20 derives respective feature quantities of the training data D2 and the training candidate data D3 in the derivation processing (S520). The derivation unit 23 copies the model M1 trained by the training device 10 to the model M3 of the training support device 20, and derives the feature quantities of the training data D2 and the training candidate data D3 by using the model M3. The derivation unit 23 may output the training candidate data D3 to the training device 10 so that the training device 10 derives the feature quantities of the training data D2 and the training candidate data D3. The derivation unit 23 derives, for each piece of training data D2, the feature quantity represented by the feature space having predetermined dimensions on the basis of the trained neural network 400 and the training data D2. The derivation unit 23 derives, for each piece of training candidate data D3, the feature quantity represented in the feature space having predetermined dimensions on the basis of the trained neural network 400 and the training candidate data D3.

The calculation unit 24 calculates at least one of the non-defective product distance E_{(OK, s)} and the defective product distance E_{(NG, s)}, for each piece of training candidate data D3, on the basis of the feature quantity of the training data D2 and the feature quantity of at least one piece of training candidate data D3 in the calculation processing (S530). The calculation unit 24 calculates at least one of the non-defective product distance E_{(OK, s)} and the defective product distance E_{(NG, s)} for all pieces of the training candidate data D3 (s is an integer from 1 to t). Further, the calculation unit 24 calculates the evaluation value Eₛ on the basis of the non-defective product distance E_{(OK, s)} and the defective product distance E_{(NG, s)} in the calculation processing (S530). The calculation unit 24 calculates the evaluation value Eₛ for all pieces of the training candidate data D3.

The selection unit 25 selects, in the selection processing (S540), the additional training data D4 from among the pieces of training candidate data D3 on the basis of at least one of the non-defective product distance E_{(OK, s)}, the defective product distance E_{(NG, s)}, and the evaluation value Eₛ calculated in the calculation processing (S530). The selection unit 25 selects the additional training data D4 from among the pieces of training candidate data D3 by using a predetermined index among the non-defective product distance E_{(OK,s)}, the defective product distance E_{(NG, s)}, and the evaluation value Eₛ. The selection unit 25 may, for example, weight respective values of the non-defective product distance E_{(OK,s)}, the defective product distance E_{(NG, s)}, and the evaluation value Eₛ, combine the values, and use a resultant value.

The selection unit 25 determines whether or not the additional training data D4 to be added as the training data D2 from among remaining pieces of training candidate data D3 exists in end determination processing (S550). The case in which the additional training data D4 does not exist means, for example, a case in which the remaining training candidate data D3 does not exist, or a case in which the non-defective product distance E_{(OK, s)}, the defective product distance E_{(NG, s)}, and the evaluation value Eₛ used by the selection unit 25 are equal to or larger than respective predetermined threshold values or smaller than the respective threshold values. When it is determined that the additional training data D4 does not exist (S550: the additional training data does not exist), the processing proceeds to the reporting processing (S590). When it is determined that the additional training data D4 exists (S550: the additional training data exists), the processing proceeds to the display processing (S560).

When the selection unit 25 determines that the additional training data D4 exists (S550: the additional training data exists), the display unit 26 displays the additional training data D4 selected by the selection unit 25 in the display processing (S560). The user can confirm the additional training data D4 displayed on the display unit 26.

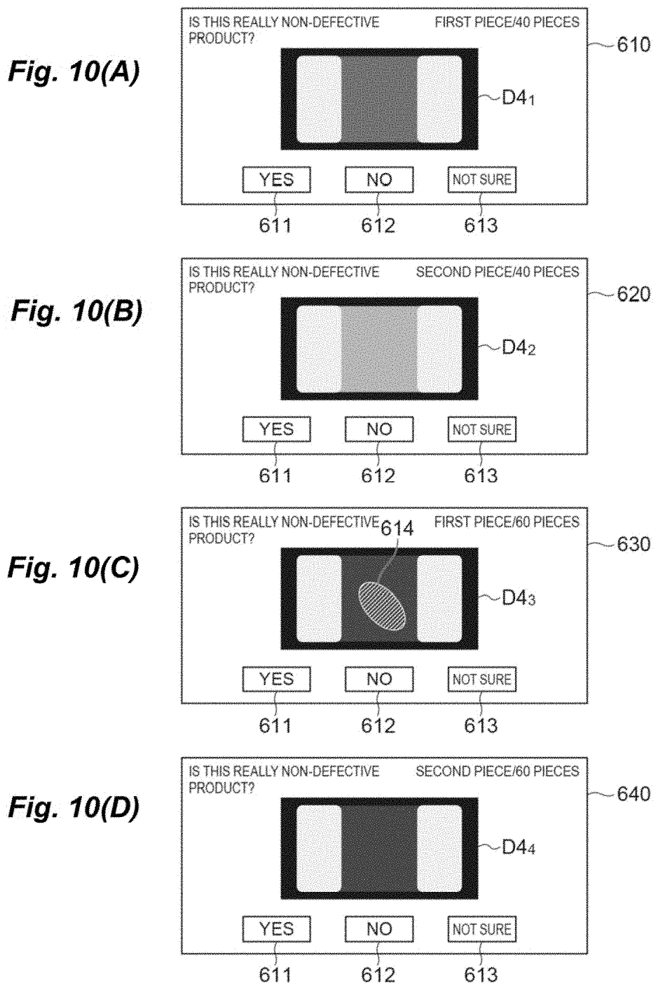

FIGS. 10(A) to 10(D) are diagrams illustrating examples of screens 610, 620, 630, and 640 displayed on the display unit 26 in the display processing (S560). An example in which a subject of the additional training data D4 is an electronic component is shown in FIGS. 10(A) to 10(D), additional training data D4₁ and D4₂ are images of data given the non-defective product label, and additional training data D4₃ and D4₄ are images of data given the defective product label.

FIG. 8 is referred to again. The changing unit 28 determines whether or not a user operation for changing the label given to the additional training data D4 displayed on the display unit 26 has been input via the input unit 27 in the input determination processing (S570). When it is determined that the user operation for changing the label given to the additional training data D4 displayed on the display unit 26 has been input via the input unit 27 (S570: YES), the processing proceeds to the change processing (S580). When it is determined that the user operation for changing the label given to the additional training data D4 displayed on the display unit 26 has not been input via the input unit 27 (S570: NO), the selection unit 25 adds the additional training data D4 to the training data D2 and the processing of S500 to S570 is repeated again.

In the additional training data D4₁ and D4₂ of FIGS. 10(A) and 10(B), since an outer shape of the subject matches the feature of the non-defective product data, but color of the entire subject is close to the feature of the defective product data, the additional training data D4₁ and D4₂ are examples of data whose calculated defective product distance is small. As an example, when the user determines that color of the subject can be allowed, the user presses an input area 611 via the input unit 27, so that the non-defective product label given to the additional training data D4₁ is maintained. On the other hand, as an example, when the user determines that the color of the subject cannot be allowed, the user presses an input area 612 via the input unit 27, so that the changing unit 28 changes the non-defective product label given to the additional training data D4₂ to the defective product label.

In the additional training data D4₃ and D4₄ of FIGS. 10(C) and 10(D), since color of a main portion of the subject matches the feature of the defective product data, but an outer shape of the subject is close to the feature of the non-defective product data, the additional training data D4₃ and D4₄ are examples of data whose calculated non-defective product distance is small. As an example, when the user determines that a defective portion 614 is included in the main portion of the subject, the user presses the input area 611 via the input unit 27 so that the defective product label given to the additional training data D4₃ is maintained. On the other hand, as an example, when the user determines that the defective portion is not included in the main portion of the subject, the user presses the input area 612 via the input unit 27 so that the changing unit 28 changes the defective product label given to the additional training data D4₄ to the non-defective product label. Further, when the user determines whether to give the non-defective product label or the defective product label to the additional training data D4, the user can also press an input area 613. In this case, the changing unit 28 may releases the addition of the additional training data D4 to the training data D2.

The changing unit 28 changes the label given to the additional training data D4 in the change processing (S580). The changing unit 28 changes the label given to the additional training data D4 on the basis of a user operation. After the changing, the selection unit 25 adds the selected additional training data D4 to the training data D2. The processing of S500 to S570 is repeated again.

When it is determined by the selection unit 25 that the training candidate data D3 that can be selected as the training data D2 does not exist (S550: the additional training data does not exist), the selection unit 25 reports to the user that the additional training data D4 does not exist, via the display unit 26 in the reporting processing (S590). The selection unit 25 controls a screen display of the display unit 26 for a predetermined time to report to the user that the additional training data D4 does not exist, and ends the flowchart of FIG. 8 after a predetermined time has elapsed.

[Program]

A training support program for functioning as the training support device 20 will be described. The training support program includes a main module, an acquisition module, a derivation module, a calculation module, and a selection module. The main module is a part that generally controls the device. The functions realized by executing the acquisition module, the derivation module, the calculation module, and the selection module are the same as those of the training data acquisition unit 21, the training candidate data acquisition unit 22, the derivation unit 23, the calculation unit 24, and the selection unit 25 the training support device 20 described above.

### Conclusion of Embodiments

According to the training support device 20 of the embodiment, the training data acquisition unit 21 and the training candidate data acquisition unit 22 acquire the training data D2 and the training candidate data D3. The derivation unit 23 derives, for each piece of training data D2 and for each piece of training candidate data D3, the feature quantity on the basis of the model M3 trained using the training data D2. The calculation unit 24 calculates at least one of the non-defective product distance E_{(OK,s)} and the defective product distance E_{(NG, s)}, for each piece of training candidate data D3. The selection unit 25 selects the additional training data D4 from among the pieces of training candidate data D3 on the basis of the distance calculated by the calculation unit 24 (at least one of the non-defective product distance E_{(OK, s)} and the defective product distance E_{(NG, s)}). As training of weighting coefficients in the neural network 400 which is an example of the models M1, M2 and M3, the training candidate data D3 that cannot be easily identified by the neural network 400 has a high training effect and can shorten a time required for training. Therefore, the selection unit 25 is required to select the data to be added as the training data D2 from among the pieces of training candidate data D3 on the basis of the level of the training effect. The training candidate data D3 having a high training effect is the training candidate data given the defective product label, which is close to the non-defective product data OK in the feature space, or the training candidate data given the non-defective product label, which is close to the defective product data NG in the feature space. The selection unit 25 uses at least one of the non-defective product distance E_{(OK, s)} and the defective product distance E_{(NG, s)} calculated by the calculation unit 24 as an index, thereby improving efficiency of processing of selecting the data to be added as the training data D2 from among the pieces of training candidate data D3 on the basis of the level of the training effect. Therefore, the training support device 20 can appropriately support the training of the model M1. The training support method and the training support program also have the same effects as described above.

The training device 10 can perform efficient training of the model M1 (the weighting coefficients in the neural network 400) by using the training data D2 having a high training effect selected by the selection unit 25.

The selection unit 25 increases the probability of the training candidate data being selected from among at least one piece of training candidate data D3 when the non-defective product distance E_{(OK, s)} of the training candidate data given the defective product label is smaller. In this case, the selection unit 25 can acquire the training candidate data given the defective product label and having a high training effect, which is close to the non-defective product data OK in the feature space, as the training data D2.

The selection unit 25 increases the probability of the training candidate data being selected from among at least one piece of training candidate data when the defective product distance E_{(NG, s)} of the training candidate data D3 given the non-defective product label is smaller. In this case, the selection unit 25 can acquire the training candidate data D3 given a non-defective product label and having a high training effect, which is close to the defective product data NG in the feature space, as the training data D2.

The selection unit 25 selects the additional training data D4 from among at least one piece of training candidate data D3 on the basis of the evaluation value Eₛ calculated by using the non-defective product distance E_{(OK, s)} and the defective product distance E_{(NG, s)} for each piece of training candidate data D3. The selection unit 25 uses both of the non-defective product distance E_{(OK,s)} and the defective product distance E_{(NG, s)}, thereby improving efficiency of processing of selecting the training candidate data D3 having a high training effect for the neural network 400 as the training data D2.

The training device 10 and the training support device 20 further include the display unit 26 that displays the training candidate data D3 selected by the selection unit 25, so that the user can recognize the training candidate data D3 having a high training effect.

Further, the training support device 20 further includes the input unit 27 that receives an input of a user operation, and the changing unit 28 that changes the label given to the training candidate data D3 when a user operation for changing the label given to the training candidate data D3 displayed on the display unit 26 is input to the input unit 27. This makes it possible for the user to perform correction of the non-defective product label or the defective product label given to the training candidate data D3 in advance while confirming the display unit 26.

Further, when the selection unit 25 determines that data to be added as the training data D2 (the additional training data D4) from among at least one piece of training candidate data D3 does not exist on the basis of the distance, the selection unit 25 causes the display unit 26 to display the determination result. In this case, the user can recognize that there is no additional training data D4 to be trained by the neural network 400, and can easily determine whether or not to end the training of the weighting coefficients.

The embodiments of the present disclosure have been described above, but the present disclosure is not limited to the above-described embodiments. Although the configuration in which the training device 10 and the training support device 20 are physically or logically separated has been described in the above-described embodiments, the training device 10 and the training support device 20 may be integrated and physically or logically integral with each other. That is, the training device 10 may be configured to include the training support device 20.

Respective components of the training support device 20 may be configured as an assembly in which devices corresponding to functions of the respective components are connected to each other via a communication network.

When the training support device 20 does not include the display unit 26, the training support method may not perform the display processing (S560). When the training support device 20 does not include the input unit 27 and the changing unit 28, the input determination processing (S570) in the training support method may not be performed.

### REFERENCE SIGNS LIST

10 . . . Training device, 11 . . . Training unit, 20 . . . Training support device, 21 . . . Training data acquisition unit, 22 . . . Training candidate data acquisition unit, 23 . . . Derivation unit, 24 . . . Calculation unit, 25 . . . Selection unit, 26 . . . Display unit, 27 . . . Input unit, 28 . . . Changing unit, 400 . . . Neural network.

1. A training support device comprising:
a training data acquisition unit configured to acquire training data having first data given a first label and second data given a second label;
a training candidate data acquisition unit configured to acquire at least one piece of training candidate data given any one of the first label and the second label;
a derivation unit configured to derive, for each piece of training data, a feature quantity of the training data represented in a feature space having predetermined dimensions, on the basis of a model trained using the training data so that target data is classified into any one of the first label and the second label, and the training data, and derive, for each piece of training candidate data, a feature quantity of the training candidate data represented in the feature space, on the basis of the model and the at least one piece of training candidate data;
a calculation unit configured to calculate, for each piece of training candidate data, at least one of a first distance, the first distance being a distance between the training candidate data and the first data in the feature space, and a second distance, the second distance being a distance between the training candidate data and the second data in the feature space, on the basis of the feature quantity of the training data and the feature quantity of the at least one piece of training candidate data; and
a selection unit configured to select data to be added as the training data from among the at least one piece of training candidate data, on the basis of the distance for each piece of training candidate data calculated by the calculation unit.

2. The training support device according to claim 1, wherein the selection unit increases a probability of the training candidate data being selected from the at least one piece of training candidate data when the first distance of the training candidate data given the second label is smaller.

3. The training support device according to claim 1, wherein the selection unit increases a probability of the training candidate data being selected from the at least one piece of training candidate data when the second distance of the training candidate data given the first label is smaller.

4. The training support device according to claim 1,
wherein the calculation unit calculates an evaluation value by using the first distance and the second distance for each piece of training candidate data, and
the selection unit selects data to be added as the training data from among the at least one piece of training candidate data, on the basis of the evaluation value for each piece of training candidate data.

5. The training support device according to claim 1, further comprising a display unit configured to display the data selected by the selection unit.

6. The training support device according to claim 5, further comprising:
an input unit configured to receive an input of a user operation; and
a changing unit configured to change the label given to the data when a user operation for changing the label given to the data displayed on the display unit is input to the input unit.

7. The training support device according to claim 5, wherein the selection unit causes the display unit to display a determination result when it is determined that data to be added as the training data from among the at least one piece of training candidate data does not exist, on the basis of the first distance and the second distance.

8. A training device comprising:
a training data acquisition unit configured to acquire training data having first data given a first label and second data given a second label;
a training candidate data acquisition unit configured to acquire at least one piece of training candidate data given any one of the first label and the second label;
a derivation unit configured to derive, for each piece of training data, a feature quantity of the training data represented in a feature space having predetermined dimensions, on the basis of a model trained using the training data so that target data is classified into any one of the first label and the second label, and the training data, and derive, for each piece of training candidate data, a feature quantity represented in the feature space, on the basis of the model and the at least one piece of training candidate data;
a calculation unit configured to calculate, for each piece of training candidate data, at least one of a first distance, the first distance being a distance between the training candidate data and the first data in the feature space, and a second distance, the second distance being a distance between the training candidate data and the second data in the feature space, on the basis of the feature quantity of the training data and the feature quantity of the at least one piece of training candidate data;
a selection unit configured to select data to be added as the training data from among the at least one piece of training candidate data, on the basis of the distance for each piece of training candidate data calculated by the calculation unit; and
a training unit configured to train the model by using the data selected by the selection unit.

9. A training support method comprising:
a first step of acquiring training data having first data given a first label and second data given a second label, and at least one piece of training candidate data given any one of the first label and the second label;
a second step of deriving, for each piece of training data, a feature quantity of the training data represented in a feature space having predetermined dimensions, on the basis of a model trained using the training data so that target data is classified into any one of the first label and the second label, and the training data, and deriving, for each piece of training candidate data, a feature quantity of the training candidate data represented in the feature space, on the basis of the model and the at least one piece of training candidate data;
a third step of calculating, for each piece of training candidate data, at least one of a first distance, the first distance being a distance between the training candidate data and the first data in the feature space, and a second distance, the second distance being a distance between the training candidate data and the second data in the feature space, on the basis of the feature quantity of the training data and the feature quantity of the at least one piece of training candidate data; and
a fourth step of selecting data to be added as the training data from among the at least one piece of training candidate data, on the basis of the distance for each piece of training candidate data calculated in the third step.

10. A non-transitory computer-readable media including a training support program for causing a computer to function as the training support device according to claim 1.
